(19) United States
(12) Patent Application Publication
(10) Pub. No.: US 2015/0264599 A1
(43) Pub. Date: Sep. 17, 2015

(54) NON-INTRUSIVE METHOD OF SENDING THE TRANSMISSION CONFIGURATION INFORMATION FROM THE TRANSMITTER TO THE RECEIVER

(71) Applicants: Aaron Kwang Ho Han, Santa Fe Springs, CA (US); Kyung-sang Yeo, Seoul (KR)

(72) Inventors: Aaron Kwang Ho Han, Santa Fe Springs, CA (US); Kyung-sang Yeo, Seoul (KR)

(73) Assignee: Cinet Inc., Santa Fe Springs, CA (US)

(21) Appl. No.: 14/205,975

(22) Filed: Mar. 12, 2014

(51) Int. Cl. H04W 28/18

(52) U.S. Cl. CPC H04W 28/18; H04W 80/04

(57) ABSTRACT

This invention proposes a new method of sending the transmission configuration information from the transmitter to the receiver. This method is non-intrusive to the transmitter requiring no inquiry, contact, or connection from the receiver, unlike the existing methods. It reduces the load on the transmitter and thus enhances the speed and the reliability of the transmission.

### BACKGROUND

Multiple televisions on a wall or over a bar are becoming popular attractions for the venues that provide retail services. The large display screens are decorative and they deliver with multiple stations/channels a wide range of entertainment.

A challenge to the multiple televisions setup is the audio distribution. For the video, the customers can focus on any particular television to watch without much interference from other nearby televisions. To hear a particular television, however, the audio from any one particular television would get mixed with other nearby televisions and become difficult.

A simple solution of the past has been to have no audio from any television or have one audio from one main television. Another more sophisticated way is to collect the audio from each television and distribute them through Wi-Fi digital transmission to individual smartphones. The customers with smartphones can then listen to the particular televisions using Apps. The advantage of the latter is that the customers can watch and listen to the televisions choosing independently and individually.

In designing the Wi-Fi digital transmission of the television audios, the UDP transmission can be used for its minimum protocol mechanism, which can translate into speed of the transmission. The UDP transmission is also called multicasting for its ability to carry multiple channels. The speed of the multicasting is advantageous in achieving the optimum synchronization of the video coming out of the television to the audio being transmitted. The delay of the audio relative to the video is referred to as the latency problem.

This invention proposes a new method of sending transmission configuration information from the transmitter to the receiver. The transmission configuration information is for example the information such as the ports and the content descriptions of the multiple channels in the UDP transmission. This new method is non-intrusive to the transmitter that the receiving devices do not contact, connect, or engage the transmitter for the information. Given the potentially large number of receiving devices and large number of inquiries per device, the non-intrusive method has the advantage of being less burdensome to the transmitter and thus potentially contributing to more reliable and speedy transmission.

This non-intrusive method also sends to the receiver any change in the transmission configuration information immediately upon occurring. The receiver can thus update the transmission configuration information instantly and provide faster service in its application.

### SUMMARY

The challenge in abstract is how to deliver the transmission configuration information from the transmitter to the receiver. A typical method (as presented in U.S. Pat. No. 8,495,236 B1 and U.S. Pat. No. 8,852,565 B1) starts with the receiver first establishing a connection to the transmitter using an IP transmission. Different types of the IP transmission, such as TCP/IP or RTP/TP can be used. Once the connection is established, the receiver receives the transmission configuration information which is either stored or generated in the transmitter. The transmission configuration information is thus sent in response to the receiver through the connection.

The receiver, having received the transmission configuration information, then makes a selection and sends a request back to the transmitter for a particular transmission among many. The transmitter opens the particular transmission and sends the selected channel to the receiver. The receiver usually utilizes a custom made App to incorporate the transform configuration information into a visual user interface. The user interface will show the available channel menu to the user, and upon a selection by the user, sends a request to the transmitter for that particular channel.

The typical method as described above however can be disadvantageous when the speed of the transmission from the source(s) of the data to the receiver is critical. One example of the setup, as described in the background, is when the transmitter is transmitting the audios of the multiple televisions into the smartphone devices using IP connection. In this case, to reduce the latency problem, the transmitter is optimized for a fast and speedy transmission. But the connection using TCP/IP or RTP/IP protocol from the receiver to the transmitter for each time of request for the transmission configuration information is a drain in the resource of the transmitter. Counting the number of smartphones that may connect to the transmitter in a single location, and the number of times that each smartphone will connect to the transmitter to change its channel selection or update the change in the transmission configuration information, the existing method of sending the transmission configuration information using an IP connection between the receiver and the transmitter can seriously hamper the transmitter from devoting its resources, such as its CPU power and data transfer capacity, to the transmitting of the data.

This invention proposes a different method of sending the transmission configuration information from the transmitter to the receiver. This method is most easily demonstrated, however not limited to, in the multiple channel UDP transmission. The UDP transmission is a “procedure for application program to send messages to other programs with a minimum of protocol mechanism”⁵. With the minimum protocol, the UDP transmission physically delivers the most data per packet relative to the protocol size. ⁵ http://tools.ietf.org/html/rfc768

By the minimum protocol, it also means that it is concerned with the transmission, not the integrity of the delivery or the loss of data. The UDP transmission is also known as multicast in the sense that the transmitter sends out the stream of datagram in multiple channels without any connection to a particular receiver. The datagram is sent out regardless of the number of the receivers and is in the sense of the word “broadcast” in multiple channels. This property leads to the shortfalls of the UDP transmission being regardless of the integrity of the received data. That is, the transmitter is not connected to the receiver(s) in the TCP/IP or RTP/IP sense to establish the integrity of the data by error checking and error correction protocols. The subject of the integrity of the received data in the UDP transmission is a topic of future research.

Using the UDP transmission to multicast the data then, the challenge is what would be an alternate or better way to deliver the transmission configuration information from the transmitter to the receiver. The previous ways of establishing an individual TCP/IP or RTP/IP connection between the transmitter and a receiver can be costly to the resources of the transmitter as described above. They are also self-defeating in the sense that the choice of UDP transmission itself is to achieve the minimum protocol, thus to the maximum speed, and yet to do so, the costly and slow TCP/IP or RTP/IP connections are established between the transmitter and the receiver(s).

This invention proposes that the transmission configuration information be sent from the transmitter as one of the channel in the multicast to the receiver. For example, in the case of transmitting the audios of multiple televisions using the UDP transmission, one additional channel will be added to the multicast sending out the transmission configuration information. The transmission configuration information will carry the descriptions of the multiple channels, such as their transmission port numbers, which describes the ports being used in the transmission, and their respective content descriptions.

The receiver, in this case, would be the smart devices such as iPhone, iPad, or Androids installed with an App designed to search for the transmission configuration information from the additional channel in the multicast. The additional channel, its port number and format, would be preset in a mutual agreement between the transmitter and the App installed in the receiver. Thus from the moment of powering on and activating, the App will search and obtain the transmission configuration information from the multicast and then from this information, generate the user interface that would display the channel menu, such as the list of televisions and their respective station names in the venue.

This invention of sending the transmission configuration information as a part of the multicast from the transmitter to the receiver carries four important advantages from existing methods. First, it separates the transmitter from the unnecessary connection of the receiver, which may be a TCP/IP or RTP/IP connection. The receiver searches and obtains the transmission configuration information from the multicast, i.e. from the transmitted Wi-Fi signals in the air, through a preset port.

Second, this new method of sending the transmission configuration information does not change whether there are one or many receivers at the receiving end. Both cases of a single or multiple receivers result in no change of load or burden to the transmitter.

Third, when the receiver changes its choice of channel, i. e. changes from the audio of one television to another, the receiver does not need to re-establish a connection to the transmitter to notify the change. The receiver using the transmission configuration information can simply follow the configuration information of the multicast to change the port accordingly, without engaging the transmitter.

Forth, any change in the transmission configuration information such as a change of station or change of transmission channel of a television is transmitted immediately through the addition channel and received by the receiver. The change does not have to wait for a time scheduled IP connection from the receiver to be reflected onto the App.

### BRIEF DESCRIPTION OF THE DRAWINGS

FIG. 1 is the layout of the transmission configuration information being sent from the transmitter to the receiver.

FIG. 2 is an example of the transmission configuration information packet (103) of FIG. 1.

FIG. 3 is an example of data packet being transmitted in one channel of the multiple channel transmission.

FIG. 4 describes the Internet Protocol architecture for the UDP transmission which is used as an example of the invention.

FIG. 5 is a detail description of the user datagram protocol (UDP) header (402).

FIG. 6 is a detail description of the transmission control protocol (TCP) header, which replaces the UDP header (402) in the TCP/IP transmission.

FIG. 7 is a detail description of the real-time transmission protocol (RTP) header, which replaces the UDP header (402) in the RTP/IP transmission.

### DETAILED DESCRIPTION

Multiple televisions on a wall or over a bar are becoming popular attractions for the venues that provide retail services. The large display screens are decorative and deliver multiple channels/stations covering a wide range of entertainment.

A challenge to the multiple televisions setup is the audio distribution. For the video, the customers can focus on any particular television to watch with their eyes without much interference from other nearby televisions. To hear a particular television, however, the audio from any one particular television would get mixed with other nearby televisions and become difficult to understand.

A simple solution of the past has been to have no audio from any television or have one audio from one main television. Another more sophisticated way is to collect the audio from each television and distribute them through Wi-Fi digital transmission to individual smartphones. The customers with smartphones can then listen to the particular televisions using Apps. The advantage of using smartphones is that the customers can watch and listen to their own selection of televisions independently and individually.

In designing the Wi-Fi digital transmission of the television audios, different types of transmission, such as TCP/IP, RTP/IP or UDP/IP, have been used. Each has its own advantage over the others in the goals of achieving a stable and speedy transmission which translates to a good sound quality and a low latency. The good sound quality and the low latency however are the two ends of a tradeoff. Different type of the transmission offers a better achievement in one at the expense of the other.

This invention relates to the transmission of the multiple channels in general. It includes the cases in which a transmission of a single channel using the TCP/IP or RTP/IP connection is used as a prelude to the multiple channel transmission. An example of the prelude would be the connection to inquire and/or share the transmission configuration information between the transmitter and the receiver before the multiple channel transmission begins.

Given a multiple channel transmission, the existing method of sharing the transmission configuration information, such as which channel and what data are being transmitted, has been to establish a single channel connection between the transmitter and the receiver. The connection may be of TCP/IP or RTP/IP type. Through the connection, the transmission configuration information is sent from the transmitter to the receiver. The transmission configuration information may be generated in the transmitter upon receiving an inquiry or pre-generated and stored in the transmitter. The transmission configuration information would contain among others the basic configuration information such as which port is being used to transmit which channel and what station is in each channel.

This invention proposes an alternative method that the transmission configuration information is transmitted in an additional channel along with the main body of the multiple channel transmission. The port for the transmission of the additional channel and the format of the data packet would be preset in a mutual agreement between the transmitter and the receiver. Thus the transmitter will transmit and the receiver will receive through the preset port. It is unlike the existing methods of the transmitter waiting for an inquiry in a connection from the receiver. The transmitter transmits the transmission configuration information into the air using Wi-Fi signal. The receiver then using the preset port and format catches the information from the Wi-Fi signal in the air and processes it for the purpose of receiving the multiple channel transmission.

The method of this invention to transmit the transmission configuration information along with the multiple channel data has the following advantages over the existing methods.

First, it separates the transmitter from the unnecessary connections with the receiver, which may be of TCP/IP or RTP/IP format. The receiver searches and obtains the transmission configuration information from the broadcast/multicast, i.e. from the transmitted Wi-Fi signals in the air using a preset port.

Second, this method of sending the transmission configuration information does not change whether there are one or many receivers at the receiving end. Both cases of a single or multiple receivers result in no change of load or burden to the transmitter.

Third, when the receiver changes its selection of the channel, that is, changes from receiving the data of one channel to another, it does not need to engage the transmitter. The receiver can simply follow the transmission configuration information and change the channel on its own.

Fourth, when the transmission configuration is changed, such as when the data in a channel is changed from one source to another or additional channels are added due to increased number of inputs, the new transmission configuration information will become available immediately to the receiver in the broadcast/multicast. The new transmission configuration information does not require another connection of inquiry from the receiver to be transmitted.

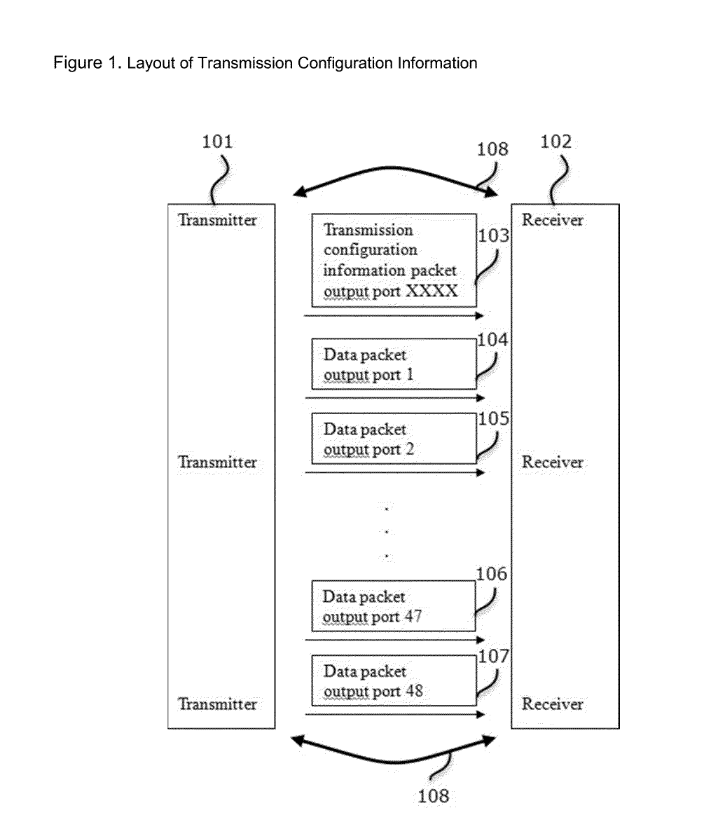

FIG. 1 is an example layout of the transmission configuration information being sent from the transmitter to the receiver. From the transmitter (101) to the receiver (102), the multiple channel transmission sends the data packets (104-107) through their channels noted port 1-48. This invention proposed that the transmitter (101) also transmits the transmission configuration information in the packet (103) in an additional channel noted by the port XXXX. The packet (103) will carry the information of the packets (104-107) and the channel information of the port 1-48. The port 1-48 can be relative addresses from the port XXXX. The port XXXX would be preset in a mutual agreement between the transmitter and the receiver. The receiver when activated will search for the packet (103) in the port XXXX, and when the packet is received, will use the information within to select any channel in the multiple channel transmission. Note that other connections (108) can be made between the transmitter and the receiver as needed. They may be of any IP connection type including the TCP/IP or RTP/IP for their purpose of application.

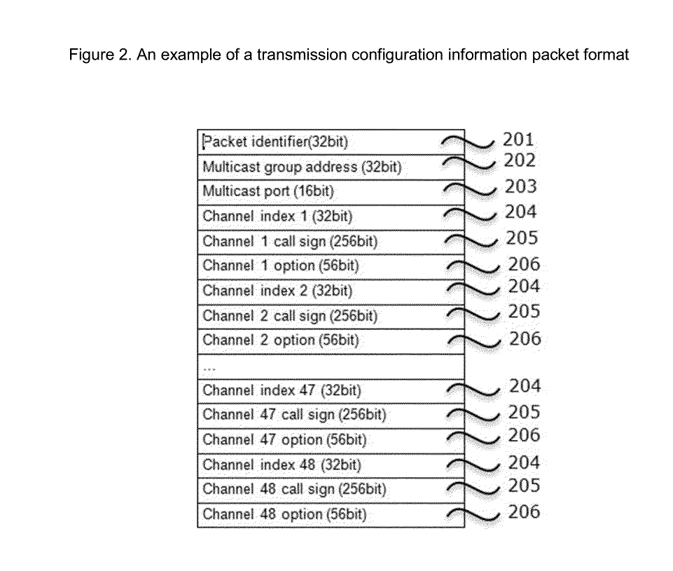

FIG. 2 is an example of the transmission configuration information packet (103) of FIG. 1. The packet identifier (201), the multicast group address (202), and the multicast port (203) are the parts that would be embedded into the transmission protocol guiding the packet into the preset port that is mutually agreed on between the transmitter and the receiver. The data packets (204-206) are the transmission configuration information of the data packets (104-107). They include the port numbers in which the transmissions are being made, the call sign that would indicate the data description, and the option that specify other relevant variables in the data. They describe each and all of the channels in the multiple channel transmissions. In this example, up to 48 channels are noted.

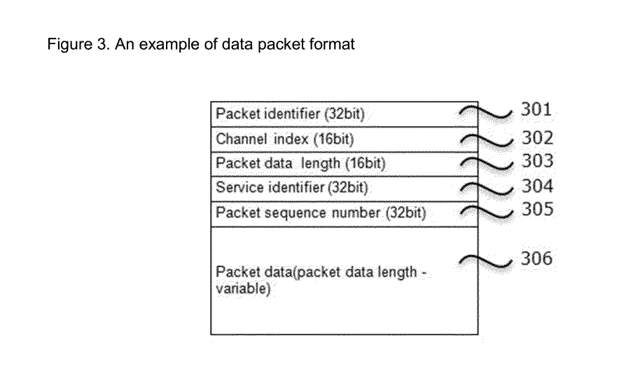

FIG. 3 is an example of data packet being transmitted in a single channel (104). It consists of transmission protocol in the packet identifier (301) and the channel index (302). The protocols will guide the packet into the port noted in the transmission configuration information. The packet would also contain the brief description of the data content such as its length, name, and sequence number as shown in (303), (304), and (305). The data itself is (306) which is being transmitted to the receiver for the application.

A concrete example of the invention can be found in the transmission of the audio outputs of the multiple televisions located in a sports bar. The audio outputs of the multiple televisions are first collected into the transmitter. The original forms of the audio outputs can be analog or digital, coming into the transmitter using RCA, USB, HDMI or any other connector. The server would then convert the audio data into the digital signal that can be replayed by the receiver, such as a smartphones and tablets, and transmits the digital signal as Wi-Fi signals.

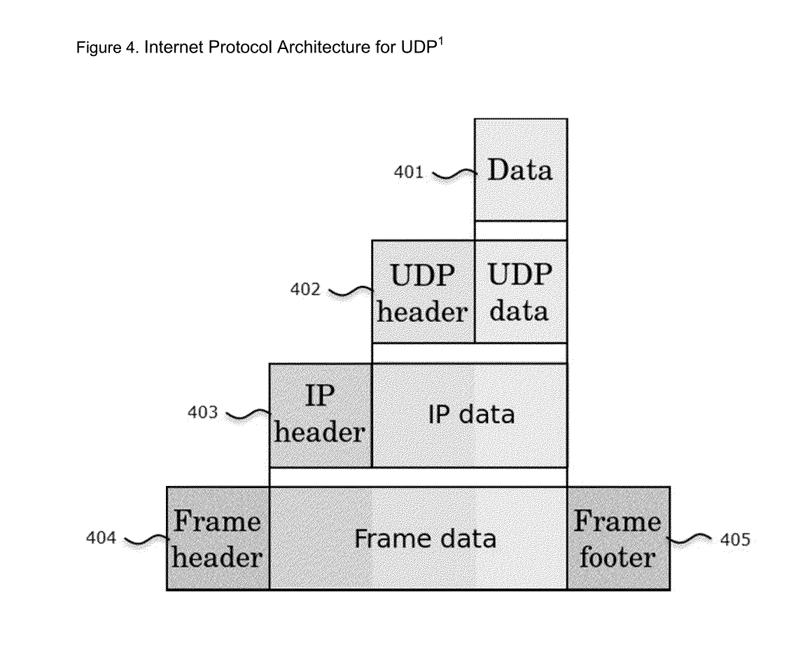

In the example, for the speedy transmission which means the low latency, the user datagram protocol (UDP/IP), also known as the multicast, is selected for the transmission. FIG. 4 describes the Internet Protocol architecture for the UDP/IP transmission. The application data (401) would be the data packet of FIG. 2 or the data packet of FIG. 3. The UDP header (402), IP header (403), and the Frame header (404) and footer (405) are the transmission protocols that would be used for transmitting the application data (401). The protocols (402), (403), (404), and (405) would reflect the values in (201), (202), (203), (301), and (302) inserted by the transmitter, thus able to be found and read by the receiver.

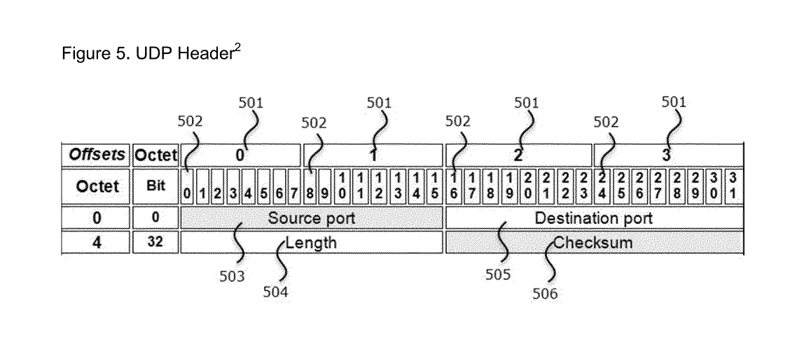

FIG. 5 is a detail description of the UDP header (402). Notably, it spends 32 bits for the transmission protocol, half of which, the source port (503) and the checksum (506), can be ignored as option in the commonly found IPv4 transmission. The small number of the protocol bits can indicate the fast speed transmission by sheer space allotted for the application data relative to the protocol. More importantly however is that the small number of protocol means less or no safety measures for the integrity of the delivered datagram, thus resulting in a faster transmission. The sole mission of the UDP/IP transmission is to send out with speed the data packet in multicast regardless of the integrity of the delivered data to the receiver. It requires only the destination port and the length of the data in the protocol.

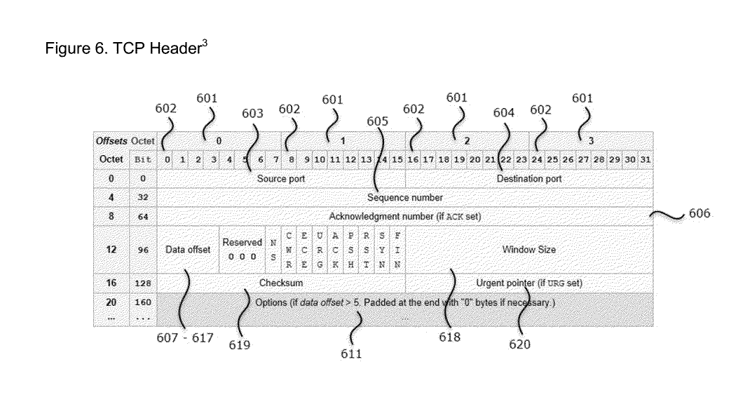

Other protocols, such as transmission control protocol (TCP) or the real-time transmission protocol (RTP) has been considered for the transmission. FIG. 6 is a detail description of the transmission control protocol (TCP) header, which for the TCP/IP transmission can replace the UDP header (402). The TCP/IP is the most commonly used IP transmission in our daily Internet surfing. It has over 128 bit of header protocol (603-620) per data packet designed heavily with the safety measures for the integrity of the received data. It incorporates the data offset, the reserved, and the control bits (607-617) as well as the window size (618) for bi-directional communication. A major delay in the TCP/IP transmission comes from this bi-directional protocol to re-transmit the data in case of data loss. The TCP/IP transmission is thus strong on the integrity of the received transmission at the cost of the transmission speed.

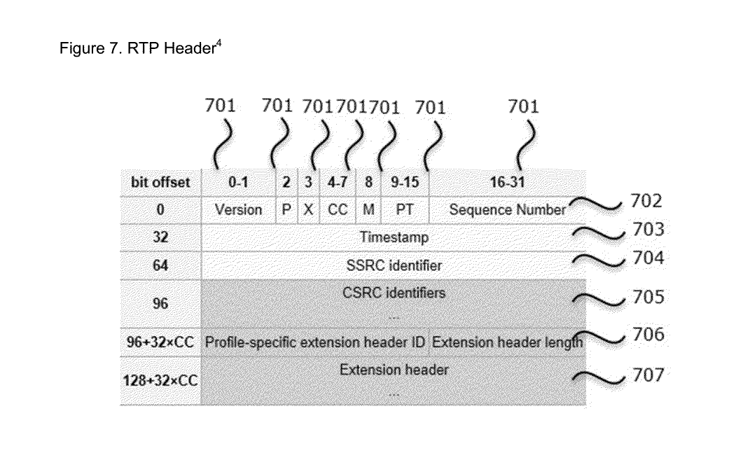

FIG. 7 is a detail description of the real-time transmission protocol (RTP) header, which is another alternative to the UDP header (402). Using the RTP header, the RTP/IP transmission is most commonly found in the voice over IP (VOIP) transmission used in the digital telephony such as Skype and Vonage. The protocol consists of minimum 96 bit protocol (702-704) which includes control bits and the sequence number (702) which would notify the receiver of lost data packets. Although the protocol does not attempt to recover the lost data packet through re-transmission, the control bits and the sequence number alerts the receiver of the lost data and in response, the receiver takes the actions to patch up the loss data. The appropriate actions by the receiver however can be another major cause of delay in the transmission.

In the example of audio transmission of the multiple televisions, the UDP/IP transmission is thus selected for its speed of transmission. Its weakness in preserving the integrity of the delivered data can be improved by the data format in the transmission rather than using the protocols. The research on how to improve the integrity of the delivered data in the UDP/IP transmission is a topic of future research.

Using the UDP/IP transmission then, the method of this invention is to deliver the transmission configuration information using an additional preset channel as shown in (103) of FIG. 1. This additional channel would be transmitted in a preset port XXXX. The receiver, which would be a device such as iPhone, iPad, or Androids, can then search for the port XXXX using an application program (also known as App), and upon finding the port and its transmission, will display the received information in a customer interface showing all selectable channels and their respective station descriptions, for example, Channel 1: ESPN, Channel 2: Fox News, Channel 3: CNN, etc.

Different from this invention, the existing methods of first establishing an IP connection between the transmitter and the receiver for the transmission configuration information are discussed in the U.S. Pat. No. 8,495,236 B1 by Glasser and U.S. Pat. No. 8,852,565 B1 by Morsy et al.

The advantage of this invention is clear that: First, the new invention separates the transmitter from the unnecessary connections with the receiver, which may be of TCP/IP or RTP/IP format. Second, the number of receiver(s) does not matter to the transmitter in terms of load or burden. Third, the receiver is free to change its selection of the channel without any response from the transmitter. Fourth, any change in the transmission configuration is immediately transmitted in the port XXXX, and be received by the receiver without any connections between the transmitter and the receiver.

What is claimed is:

1. A method of sending the transmission configuration information from a transmitter to a receiver that comprises of:
a transmitter of data
a receiver of data
a transmission of data
a transmission of the transmission configuration information
a preset channel/protocol to send and receive the transmission configuration information between the transmitter and the receiver
a preset format of the transmission configuration information to send and receive the transmission configuration information between the transmitter and the receiver

2. The system of claim 1, where the transmitter transmits the multiple channels of data.

3. The system of claim 1, where the transmitter transmits the audio outputs of external sources such as televisions.

4. The system of claim 1, where the transmitter consists of a server and a router.

5. The system of claim 1, where the transmitter transmits in digital signal using the Internet protocol.

6. The system of claim 1, where the transmission is of the UDP/IP protocol also known as the multicast.

7. The system of claim 1, where the transmission of the transmission configuration information is done using an additional channel in the multiple channel transmission.

8. The system of claim 1, where the receiver is a device capable of receiving IP transmission, such as iPhone, iPad, Android smartphones, and Android tablets.

9. The system of claim 1, where there are multiple receivers, each representing a receiver of the transmission.
